(19) United States
(12) Patent Application Publication
(10) Pub. No.: US 2023/0388852 A1
(43) Pub. Date: Nov. 30, 2023

(54) BASE STATIONS, USER EQUIPMENTS, NETWORK ENTITY

(71) Applicant: Sony Group Corporation, Tokyo (JP)

(72) Inventors: Vivek SHARMA, Basingstoke (GB); Yuxin WEI, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/032,568

(22) PCT Filed: Oct. 28, 2021
(86) PCT No.: PCT/EP2021/079983

§ 371 Date: Apr. 19, 2023

(30) Foreign Application Priority Data
Oct. 30, 2020 (EP) 20204955.7

(51) Int. Cl. H04W 28/06; H04L 69/22

(52) U.S. Cl. CPC H04W 28/065; H04L 69/22

(57) ABSTRACT

The present disclosure generally pertains to a base station for a mobile telecommunications network, wherein the base station is configured to transmit a predefined protocol data unit according to a predefined protocol of the mobile telecommunications network across a number of signaling legs, the base station having circuitry configured to: adapt the number of signaling legs based on at least one signaling condition, wherein the protocol data unit is distributed across the number of signaling legs.

### TECHNICAL FIELD

The present disclosure generally pertains to base stations, user equipments, and a network entity.

### TECHNICAL BACKGROUND

Several generations of mobile telecommunications systems are known, e.g. the third generation (“3G”), which is based on the International Mobile Telecommunications-2000 (IMT-2000) specifications, the fourth generation (“4G”), which provides capabilities as defined in the International Mobile Telecommunications-Advanced Standard (IMT-Advanced Standard), and the current fifth generation (“5G”), which is under development and which might be put into practice in the year 2020.

A candidate for providing the requirements of 5G is the so-called Long Term Evolution (“LTE”), which is a wireless communications technology allowing high-speed data communications for mobile phones and data terminals and which is already used for 4G mobile telecommunications systems. Other candidates for meeting the 5G requirements are termed New Radio (NR) Access Technology Systems. An NR can be based on LTE technology, just as some aspect of LTE was based on previous generations of mobile communications technology.

LTE is based on the GSM/EDGE (“Global System for Mobile Communications”/“Enhanced Data rates for GSM Evolution” also called EGPRS) of the second generation (“2G”) and UMTS/HSPA (“Universal Mobile Telecommunications System”/“High Speed Packet Access”) of the third generation (“3G”) network technologies.

LTE is standardized under the control of 3GPP (“3rd Generation Partnership Project”) and there exists a successor LTE-A (LTE Advanced) allowing higher data rates than the basic LTE and which is also standardized under the control of 3GPP.

For the future, 3GPP plans to further develop LTE-A such that it will be able to fulfill the technical requirements of 5G.

As the 5G system may be based on LTE-A or NR, respectively, it is assumed that specific requirements of the 5G technologies will, basically, be dealt with by features and methods which are already defined in the LTE-A and NR standard documentation.

Additionally, for New Radio (NR) specific NR functionalities are known, such as Enhanced Mobile Broadband (eMBB), and Ultra Reliable & Low Latency Communications (URLLC).

For instance, for these functionalities an accurate timing and positioning may be useful or required, for example, in the context of industrial internet of things (HOT) scenarios in non-public networks (NPN), which have been specified by 3GPP. A broadcast of system information including, for example, time-sensitive network information (time reference) or positioning assistance information is known and can be used, to support such scenarios.

Although there exist techniques for reducing data flow in a mobile-communications network, it is generally desirable to improve the existing techniques.

### SUMMARY

According to a first aspect the disclosure provides a base station for a mobile telecommunications network, wherein the base station is configured to transmit a predefined protocol data unit according to a predefined protocol of the mobile telecommunications network across a number of signaling legs, the base station comprising circuitry configured to:
adapt the number of signaling legs based on at least one signaling condition, wherein the protocol data unit is distributed across the number of signaling legs.

According to a second aspect, the disclosure provides a user equipment for a mobile telecommunications network including a base station configured to transmit a predefined protocol data unit according to a predefined protocol of the mobile telecommunications network across a number of signaling legs, the base station comprising circuitry configured to: adapt the number of signaling legs based on at least one signaling condition, wherein the protocol data unit is distributed across the number of signaling legs, wherein the user equipment comprises circuitry configured to:
receive the predefined protocol data unit across the number of signaling legs.

According to a third aspect, the disclosure provides a network entity fora mobile telecommunications network, wherein the network entity is configured to generate a predefined protocol data unit according to a predefined protocol of the mobile telecommunications network, the network entity comprising circuitry configured to:
generate a modified protocol data unit based on a predefined context of the network entity.

According to a fourth aspect, the disclosure provides, a user equipment for a mobile telecommunications network including a network entity configured to generate a predefined protocol data unit according to a predefined protocol of the mobile telecommunications network, the network entity comprising circuitry configured to: generate a modified protocol data unit based on a predefined context of the network entity, wherein the user equipment comprises circuitry configured to:
receive the modified protocol data unit.

According to a fifth aspect, the disclosure provides a base station for a mobile telecommunications network, wherein the base station is configured to generate a predefined protocol data unit according to a predefined protocol of the mobile telecommunications network, the base station comprising circuitry configured to:
generate a modified protocol data unit, wherein a modification of the predefined protocol data unit is indicated in a control layer of the protocol data unit.

According to a sixth aspect, the disclosure provides a user equipment for a mobile telecommunications network including a base station configured to generate a predefined protocol data unit according to a predefined protocol of the mobile telecommunications network, the base station comprising circuitry configured to: generate a modified protocol data unit, wherein a modification of the predefined protocol data unit is indicated in a control layer of the protocol data unit, wherein the user equipment is configured to:
receive the modified protocol data unit.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts a DL MAC PDU as specified in 3GPP TS 38.321;

FIG. 2 depicts a PDU header in case of an 18 bit SN without SO as specified in 3GPP TS 38.322;

FIG. 3 depicts a PDU header in case of a 12 bit SN with SO according to 3GPP 38.322;

FIG. 4 depicts a PDCP data PDU format according to 3GPP TS 38.323;

FIG. 5 depicts a DL SDAP data PDU as specified in 3GPP TS 37.324;

FIG. 6 depicts a UL SDAP data PDU as specified in 3GPP TS 37.324;

FIG. 7 shows an embodiment of a segmentation according to the present disclosure;

FIG. 8 depicts information needed by a UE;

FIG. 9 is an exemplary diagram to describe a training of an artificial intelligence;

FIG. 10 schematically shows an embodiment of a deployment of a mobile telecommunications network according to the present disclosure;

FIG. 11 schematically shows a further embodiment of a deployment of a mobile telecommunications network according to the present disclosure;

FIG. 12 schematically shows a further embodiment of a deployment of a mobile telecommunications network according to the present disclosure;

FIG. 13 illustrates an embodiment of a user equipment and a base station according to the present disclosure; and

FIG. 14 depicts an embodiment of a general, purpose computer according to the present disclosure.

### DETAILED DESCRIPTION OF. EMBODIMENTS

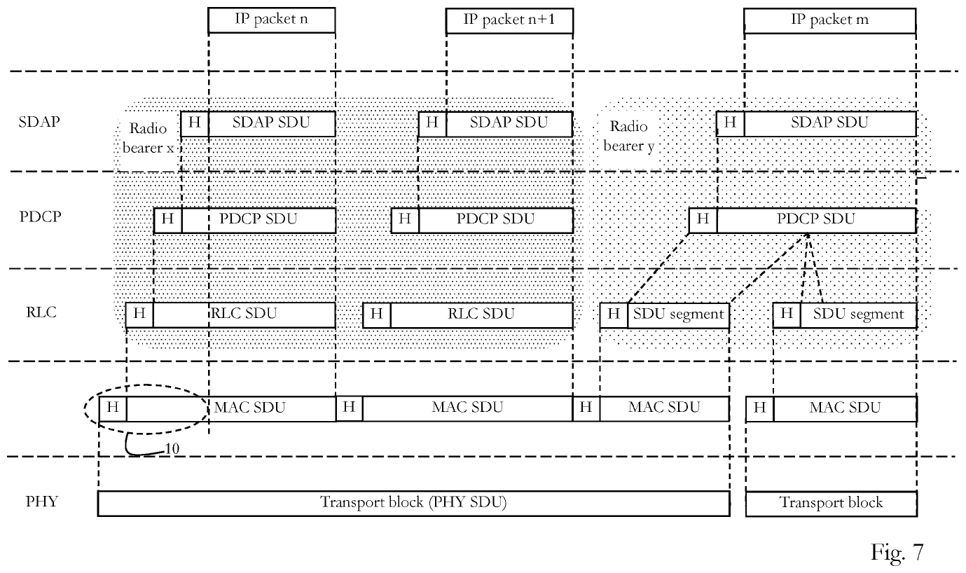

Before a detailed description of the embodiments under reference of FIG. 7 is given, general explanations are made.

Initial discussions regarding 5G concerned the need and functions of each protocol layer. For example, it was discussed to remove an RLC (radio link control) sub-layer from the 5G protocol stack, which was however not successful.

Known wireless communication systems, such as LTE (long term evolution), NR (new radio) may be based on predefined, protocol stacks and a predefined PDU (packet data unit) structure.

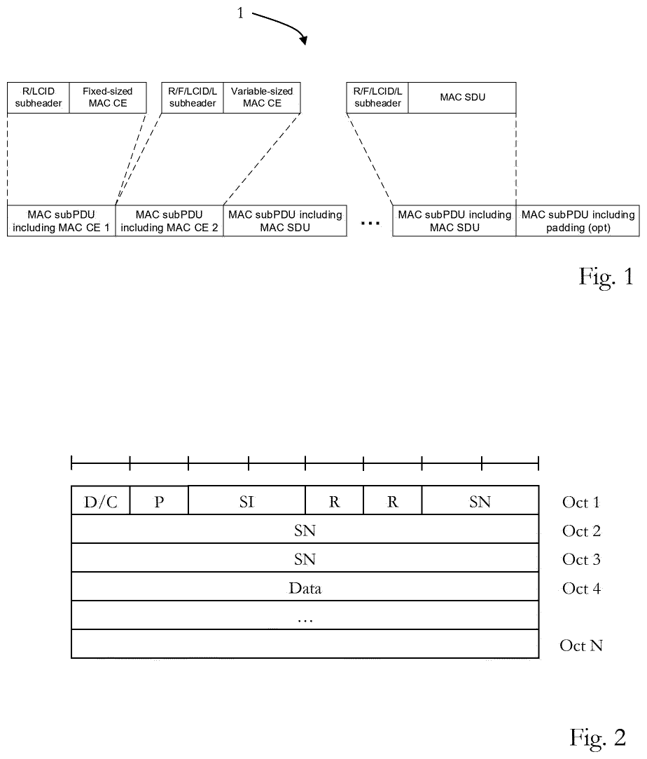

For example, 3GPP document TS 38.321 specifies a DL MAC PDU (DL: downlink; MAC: medium access control), as shown in FIG. 1.

The DL MAC PDU 1 has a predefined vertically and horizontally layered structure having a plurality of MAC subPDUs all bearing different information. For example, the MAC subPDU including MAC CE 1 (CE: control element) includes an R/LCID subheader (LCID: logic channel ID) and has a fixed-sized MAC CE. Furthermore, the MAC subPDU including MAC CE 2 includes an R/F/LCID/L subheader and has a variable-sized MAC CE. The MAC subPDU including MAC SDU (service data unit includes an R/F/LCID/L subheader and the MAC SDU.

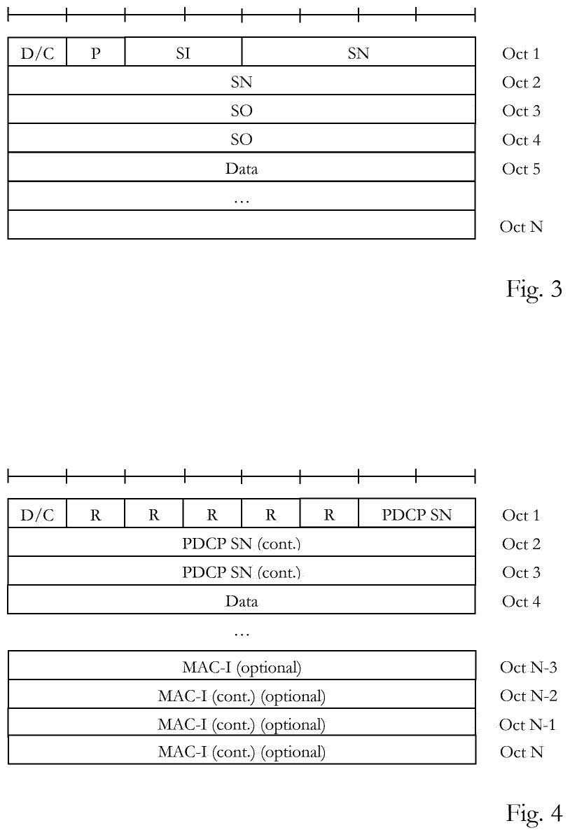

FIGS. 2 and 3 show an AMD PDU (AMD: acknowledge mode data) as specified in 3GPP TS 38.322. Generally, an AMD PDU header includes a D/C, a P, an SI, and an SN field. Furthermore, the AMD PDU includes a data field.

The header, according to 3GPP TS 38.322, is byte aligned. In case of an 18 bit SN without SO (segment offset), as shown in FIG. 2, the PDU header includes a D/C, a P, an S, two R, and an SN field, whereas in case of a 12 bit SN with SO, the header includes a D/C, a P, an SI, and an SN field, as shown, in FIG. 3.

According to 3GPP specification TS 38.323, which defines a PDCP (packet data convergence protocol) data PDU format for DRBs (data radio bearer) with 18 bits PDCP SN, as shown in FIG. 4, apart from a header and a data layer, further layers may be included for MAC-I (message authentication code for integrity). The PDU header, in this case, includes a D/C field, five R fields, and PDCP SN fields.

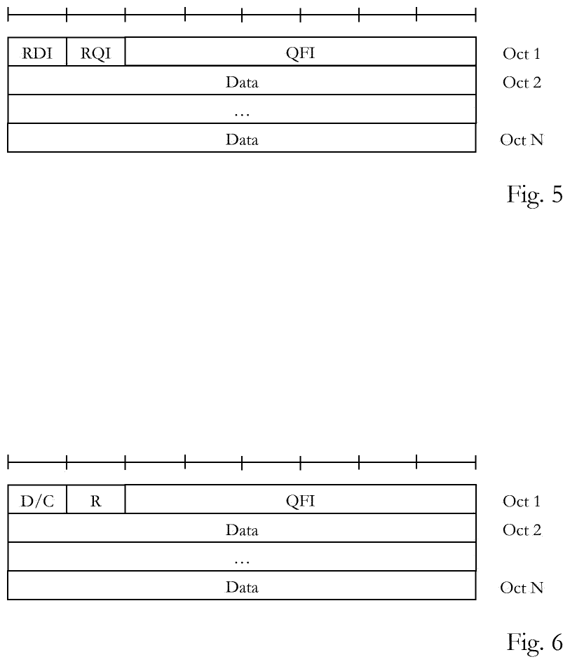

As specified in 3GPP TS 37.324, a DL SDAP (service data adaptation protocol) data PDU format with an SDAP header may be defined as depicted in FIG. 5, whereas a UL (uplink) SDAP data PDU format with an SDAP header may be defined as depicted in FIG. 6.

However, in all these examples of PDU data format described with respect to FIGS. 1 to 6 and as defined in known standards, the PDU format has been recognized to be strictly defined. Hence, it has been recognized that it, may be desirable to provide a more flexible PDU format.

Although there are multiple header formats available, as discussed with respect to FIGS. 1 to 6, such a PDU design may not fulfill future application's requirement, for example with respect to URLLC (ultra-reliable low latency communications), for example, since known header formats may still include information, which may not be needed on a UE side or a base station side. Which information is carried in the PDU may depend on a type of UE, a context of a base station, or the like. For example, in autonomous driving, different information may be needed than in, a mobile phone. Hence, by providing a flexible PDU format according to the present disclosure, a flexible data transmission scheme may be provided.

Furthermore, it has been recognized that current PDU formats may impose a heavy (control signaling) burden, i.e. for example, a too lengthy header (with not needed information, for example) may occupy a considerable (amount of) radio resource, especially when the data itself is relatively small, which may apply, for example, to a small control packet, a heart-beat packet, or the like.

It has further been recognized that URLLC traffic may be considered as delay sensitive and, it may be desirable to avoid any retransmission. Hence, URLLC may be configured with multiple duplication legs, such that the same data may be sent via the multiple legs (or a subset of a maximum number of legs) in order in ensure that the transmission is successful.

Hence, it has been recognized that a compact protocol stack may be applicable for URLLC. It has further been recognized that a WiFi MAC (i.e. PDCP/RLC integrated into a MAC layer) may not be feasible due to a mobility of e.g. a UE within 3GPP since a PDCP entity may act as a mobile anchor.

Therefore, some embodiments pertain to a base station for a mobile telecommunications network, wherein the base station is configured to transmit a predefined protocol data unit according to a predefined the mobile telecommunications network across a number of signaling legs, the base station comprising circuitry configured to: adapt the number of signaling legs based on at least one signaling condition, wherein the protocol data unit is distributed across the number of signaling legs.

The base station may be implemented as a known type of base station, such as an evolved node base station (eNodeB), such that known protocol stacks may be used to implement the disclosure. For example, a 5G protocol stack may be used for URLLC according to the present disclosure. However, the present disclosure is not limited to an application within URLLC since it may be applied to eMBB (enhanced mobile broadband), mMTC (massive machine type communications), or the like, as well.

The protocol data unit may generally be predefined, as discussed herein, according to a 3GPP specification, for example according to a PDCP, RLC, or the like.

Hence, the mobile telecommunications network may be adapted to transmit a wireless radio signal according to LTE, new radio (NR), or the like, or any other mobile telecommunications protocol. Therefore, the mobile telecommunications network may include UEs (user equipment), base stations, and the like.

Generally, the mobile telecommunications network may transmit such a signal across a number of signaling legs (e.g. channels).

Although the PDU may be predefined, the base station (or a network entity) according to the present disclosure may be configured to change a structure of the PDU, as discussed above. How such a structure may be changed, will be discussed further below.

Furthermore, the number of signaling legs will be adapted, e.g. based on at least one signaling condition. For example, if the at least one signaling condition is good, a low number (e.g. one) of signaling legs may be utilized since it may be secured, in such a case, that the PDU is transmitted properly. If the at, least one signaling condition is bad, the number of signaling legs may be increased.

In some embodiments, the at least one signaling condition includes at least one of a radio condition, a service requirement, and a data size.

In some embodiments, the at least one radio condition includes: reference signal received power (RSRP), channel quality indicator (CQI), block error rate (BLEB), and the like. Furthermore, for evaluation of a radio condition, other indicators may be taken into account, such as weather, landscape, population (density), number of UEs, and/or the like.

The protocol data unit may be distributed across the number of signaling legs. In other words, a part of the PDU may be included in one signaling leg and another part may be included in another signaling leg, for example. In the case of a transmission via (only) one signaling leg, the PDU may be fully included in the one signaling leg or may be reduced, as well, depending on whether the whole information included in the PDU is considered as useful to the UE or not.

In some embodiments, a PDU format is designed based on an artificial intelligence. In other words, a modified PDU may be generated by the artificial intelligence, for example based on the at least one signaling condition, at least one service requirement, at least one transmission scheme, and/or based on a learning from segmentation and/or a reassembly pattern, or the like. The PDU format may be designed individually for each signaling leg. However, for different signaling legs, the same PDU format may be designed. Hence, in some embodiments, the circuitry is further configured to transmit at least one modified protocol data unit across the number of signaling legs.

In some embodiments, the circuitry is further configured, to transmit configuration information to a user equipment, such that the user equipment is able to transmit the modified protocol data unit.

In some embodiments, the circuitry is further configured to receive the modified protocol data unit from the user equipment.

In some embodiments, a format indicator indicates which PDU format is adopted, (i.e. indicating the modified PDU).

For example, the format indicator may be included in a control part (e.g. RRC or MAC), or the like.

For example, certain parts of the PDU (format) in each layer (e.g. SN, SO, or the like) may be removed or added compared to the predefined PDU (format). For example, if the at least one signaling condition is considered as reliable and/or a UE will not move within a predetermined amount of time (e.g. such that no handover is needed or radio measurements are stable over a period of time), the SN, part of the RLC layer may be removed, but the SN part in, the PDCP (if the predefined PDU includes RLC UMD and PDCP) may be kept. In some embodiments, the SN part may be removed in both RLC and PDCP or indicated by a truncated or short SN.

In such a case, corresponding parts or layers of the PDU may be reordered, in some embodiments.

Thus, in some embodiments, the at least one modified protocol data unit is based on a reordering of the predefined protocol data unit.

In some embodiments, a predetermined part of the PDU (in each layer) is compressed. In other words, in some embodiments, the at least one modified protocol data unit is based on a compression of a predetermined, part of the predefined protocol data unit. Whether the predetermined part (e.g. SO) is compressed (or generally modified) or not may be determined by the artificial intelligence, but may, in some embodiments be depending on a predetermined context, as will be discussed further below. Hence, in some embodiments, the adapting of the number of signaling legs may further be based on a predetermined context of the base station.

For example, the SN size in an RLC PDU or PDCP PDU may be six, twelve, or eighteen bits, for example and may be combined with various SO sizes. Hence, multiple combinations of SN and SO may be made.

A decision, which combination is best suitable may be made based on an input, e.g. at east one signaling condition, radio condition, a packet size, or the like.

Hence, in some embodiments, the modification of the PDU is based on a packet size.

In some embodiments, different protocol layers may be jointly optimized.

As discussed, an indicator is envisaged, in some embodiments, which may be added to the PDU format for identifying which format is used. In such embodiments, blind decoding may be avoided.

Such an indicator may be applied to at least one layer of the PDU, but may generally be applicable to each layer, or may be added to the PDU as a whole (e.g. in MAC PDU and may thus include format information of RLC and PDCP, for example).

In some embodiments, the mobile telecommunications network is configured to exchange (transmit/receive) assistance information with (to/from) a UE. The assistance information may be indicative for the PDU format and/or for the number of signaling legs and/or of the distribution of the PDU across the number of signaling legs.

For example, the assistance information may be indicative for the at least one signaling condition.

In some embodiments, based on the assistance information, the mobile telecommunications network and the UE may employ the same artificial intelligence (neural network), such that the mobile telecommunications network and the UE make the same decision pertaining to which PDU format the communication will be based on. Hence, in such embodiments, blind decoding may be avoided.

In some embodiments, the (predefined) PDU is modified and/or distributed across the number of signaling legs based on segmentation information and/or reassembly information of the predefined protocol data unit). For example, information from transmitting or receiving an RLC entity about segmentation or reassembly may be used to optimize the RLC SN length and size. For example, a PDCP SDU/PDU of 1500 bytes may be passed to the RLC layer as an RLC SDU. The RLC SDU is then segmented into four RLC PDUs based on at least one of the following: UL grant (uplink grant), TB size (transport block size) and at least one signaling condition.

These four segmented PDUs may carry an associated RLC SN over an air interface. In case the at least one signaling condition (e.g. radio condition) remains the same, such that the UL grant in a scheduler may follow the same policy for at least one subsequent transmission from a corresponding UE, in some embodiments, this behavior (i.e. UL grant, TB size and/or the at least one signaling condition) is used as a training input for the artificial intelligence. Hence, in the at least one subsequent transmission, the RLC SN may be not included or removed from the segmented PDUs or a shorter version of the RLC SN may be included.

For example, a reserved bit may be used to indicate whether the full or short (or no) RLC SN is used, such that backward compatibility is ensured. In this example, a short RLC SN of 0, 1, 2, 3 could be added to each of the four RLC PDUs which are corresponding to the same PDCP SN and PDCP PDU. A full PDCP SN should be included in one of the RLC PDUs so that the receiver is aware that PDCP PDU was segmented to four RLC PDUs (optional).

An embodiment of a segmentation according to the present disclosure is shown in FIG. 7. According to an artificial intelligence decision, for IP packet m and its corresponding RLC PDUs, in the header, the SN is removed since the at least one signaling condition remains the same as in a previous transmission.

On the other hand, IP packets n and n+1 the header's SN is kept since it is decided that for these IP packets reliability is important.

In some embodiments, such a (short) transmission format is applied to an LCID in a MAC header and/or to a QFI in an SDAP header.

A training input for the artificial intelligence for designing the PDU format includes at east one of the following:
1. At least one signaling condition (e.g. radio condition (e.g. RSRP, CQI, BLEB, as discussed herein))
2. Mobility status (network side and/or UE side)
3. At least one service requirement
4. Packet size
5. Position information

In some embodiments, the mobility status includes (at least one of): high speed, nomadic, static.

In some embodiments, the at least one service requirement includes (at least one of): eMBB, low latency, high reliability.

In some embodiments, the position information includes (at least one of): cell center or cell edge. Furthermore, the position information may be indicative for at least one of a geographical position (e.g. coordinates), whether the UE is inside or outside of a building, or the like.

Referring back to FIG. 7, a circled area 10 is depicted symbolizing information, which is not needed according to the present disclosure in a UE.

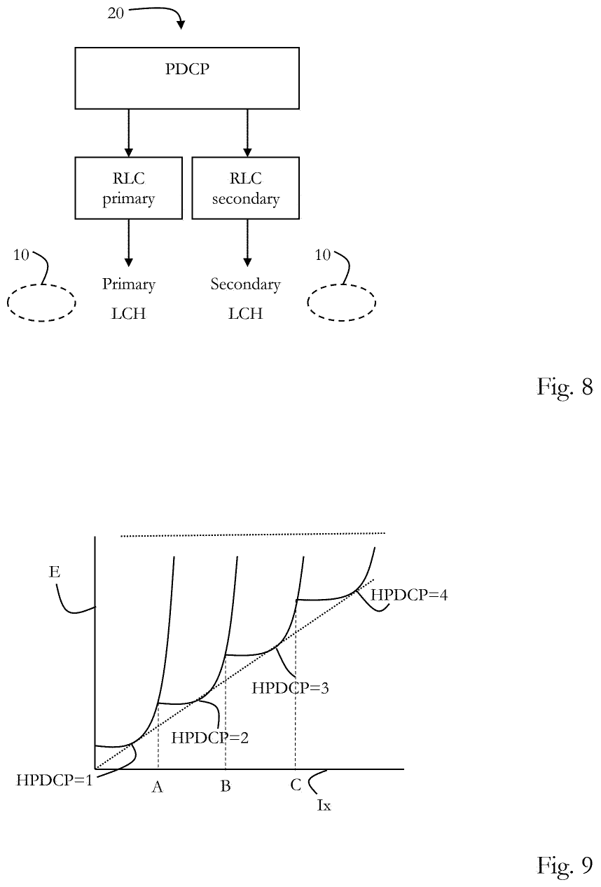

The information 20, which is needed by the UE is depicted in FIG. 8. However, in known mobile telecommunications network, also the information 10 of the MAC SDU carrying SDAP/PDCP/RLC layer header, may be transmitted, whereas within the PDCP, only primary or secondary RLC may be needed and decoded by the UE, such that, according to the present disclosure, the information 10 may be removed from the MAC SDU.

As already discussed, the number of legs may be adapted based on the at least one signaling condition.

In some embodiments, if it is determined that the at least one signaling condition has not changed for a predetermined amount, of time, the circuitry is further configured, to reduce (dynamically) the number of signaling legs.

In some embodiments, if RLC SN are synchronized or synchronized with a same value at a time of duplication, a predetermined number of legs may carry the full SN or a shorter form of SN (e.g. compressed, shortened, or the like), whereas another predetermined number of legs may carry an indication referring to the full SN or may carry an empty field instead of a full SN.

For example, one subset of legs may carry RLC-AM/UM (with RLC SN and header) and another subset of legs may carry RLC-TM (without an RLC header). For example, if the legs are enumerated, leg 1 may carry RLC-UM and leg 3 may carry RLC-TM and may allow a dynamic change of an RLC mode. MAC header fields, LCID and L may be kept static, such that one leg may carry a full value indicating the RLC PDU, whereas another leg may carry a shorter form of SN or an indication referring to the full value.

In some embodiments, an RLC mode change may be carried out dynamically or semi-statically. More generally speaking: a transmission mode change may be carried out dynamically or semi-statically based on the number of signaling legs.

A dynamic change of the RLC mode may be indicated in an RLC header, or more generally speaking: a dynamic change may be indicated in the PDU. For example, if the RLC mode changes from RLC-AM/UM to RLC-TM, the RLC header may include an indication thereof.

The indication may be determined in a next reception or may be based on a predefined SN. In other words: the dynamic change may be indicated in, a subsequent transmission of the PDU.

The indication may additionally or alternatively included in a PDCP or in a MAC header since, in a case that the RLC mode changes from RLC-TM to RLC-AM/UM, it might not be indicated in a header since RLC-TM typically has no header.

A semi-static change of the RLC mode may be carried out via dedicated signaling (e.g. RRC signaling), in some embodiments.

In some embodiments, the semi-static change indicates in which subsequent transmission the transmission mode change happens. For example, in the of case of RRC signaling, a future SN after which the change will apply is transmitted. Thereby, data loss may be avoided.

In some embodiments, an RLC-TM entity as well as an RLC-AM/UM entity may be configured in advance and a change of the RLC mode may be indicated by a future SN or immediately. Thereby, data loss may be avoided.

For a transition from RLC-AM/UM to RLC-TM, each state variable for RLC-AM/UM mode may be reset at both transmitter and receiver side as soon as the indication for the change/transition is received.

In some embodiments, for such a transmission, pre-signaling is envisaged, such that a signal delivery may be ensured and the (moment of) transition may not be distorted by a reception of an out of sequence packet.

In some embodiments, apart from the distribution of the PDU across the legs, within one leg, the PDU may be modified/adapted.

For example, if no segmentation is performed in the RLC, the size of the PDCP PDU is equal to, the RLC PDU. In such a case, PDCP SN and RLC SN fields may be of the same length and may be synchronized (e.g. by a same value or by a common offset). Thereby, only one of the PDCP SN or the RLC SN can be used.

In such embodiments, it may be envisaged that the RLC layer strips the PDCP SN from the received PDCP PDU and adds its own RLC SN (which may be the same as the PDCP SN or may have a mapping to the PDCP SN). The RLC may additionally signal to a receiver in order to increment the PDCP SN according to the received RLC SN. Such an approach may save twelve bits per leg (e.g. six octets across four legs) per packet, for example.

In some embodiments, an RRC configured the RLC-TM mode for a URLLC packet duplication. In such a case, the PDCP SN may be kept, but the RLC layer may be transparent, i.e. the RLC layer may not add any header.

Furthermore, in such embodiments, the PDCP entity may be configured to discard duplicate packets (instead of an RLC ARQ (automatic repeat request)).

In case there is a PDU missing in a PDCP layer, this missing PDU may be requested using a PDCP status report, such that a UE and/or the mobile telecommunications network may be configured to request or generate the PDCP status report.

Hence, the RLC layer may not be present for URLLC traffic, which may be configured in the beginning of a connection to the UE (i.e. RRC signaling) or during the connection (i.e. PDCP/RLC/MAC/PHY signaling).

If the at least one signaling condition is above a predetermined value (e.g. in case of (very) good radio conditions), which may be determined by the artificial intelligence or a machine learning algorithm, both PDCP and RLC SN may be skipped and a reduced PDU format may be signaled.

Some embodiments pertain to a base station for a mobile telecommunications network, wherein the base station is configured to generate a predefined protocol data unit according to a predefined protocol of the mobile telecommunications network, the base station comprising circuitry configured to: generate a modified protocol data unit, wherein a modification of the predefined protocol data unit is indicated in a control part of the protocol data unit.

Generally, according to the present disclosure, embodiments which pertain to the modification of a PDU may be implemented to embodiments which pertain to the distribution of the PDU across the number of signaling legs, and vice versa, such that a repetitive description of such embodiments will be omitted.

In such embodiments, for example, a subset to all fields in a header of the PDU for one leg are configured via control plane signaling, for example. An index indicating the field of the header may be added to a user plane packet.

The index may correspond to a set of parameters which may be added, for example, in a MAC layer (or any other (control) layer) of the transmitter (i.e. the base station), for example, which exemplifies a control part mentioned above.

A receiving entity (e.g. a UE) may be configured to map the transmitted index to the header fields. The index may be, implemented as an SN value, a counter value, or the like.

In some embodiments the circuitry is further configured to receive a modified protocol data unit from the user equipment and to decode the modified protocol data unit.

In some embodiments, the decoding of the modified protocol data unit received from the user equipment includes blind decoding.

Accordingly, some embodiments pertain to a user equipment for a mobile telecommunications network including a base station configured to transmit a predefined protocol data unit according to a predefined protocol of the mobile telecommunications network across a number of signaling legs, the base station comprising circuitry configured to: adapt the number of signaling legs based on at least one signaling condition, wherein the protocol data unit is distributed across the number of signaling legs, wherein the user equipment comprises circuitry configured to: receive the predefined protocol data unit across the number of signaling legs, as discussed herein. In some embodiments, the at least one signaling conditions includes at least one of a radio condition, a service requirement, and a data size, as discussed herein. In some embodiments, the at least one radio condition includes: reference signal receiver power, channel quality indicator, block error rate, as discussed herein. In some embodiments, the circuitry is further configured to transmit, to the base station, the modified protocol data unit across the number of signaling legs, as discussed herein. In some embodiments, the circuitry is further configured to receive at least one modified protocol data unit across the number of signaling legs, as discussed herein. In some embodiments, the circuitry is further configured to transmit, to the base station, the at least one modified protocol data unit across the number of signaling legs based on configuration information provided by the base station, as discussed herein. In some embodiments, the at least one modified protocol data unit is based on a reordering of the predefined protocol data unit, as discussed herein. In some embodiments, the modified protocol data unit includes a format indicator indicating the at least one modified protocol data unit. In some embodiments, the format indicator is included in a control part of the at least one modified protocol data unit, as discussed herein. In some embodiments, the at least one modified protocol data unit is based on a compression of a predetermined part of the predefined protocol data unit, as discussed herein. In some embodiments, the circuitry is further configured to exchange assistance information with the base station, as discussed herein. In some embodiments, the assistance information is indicative of the distribution of the protocol data unit across the number of signaling legs, as discussed herein. In some embodiments, the assistance information is indicative for at least one of the at least one signaling, as discussed herein. In some embodiments, the predefined protocol data unit is distributed across the number of signaling legs based on segmentation information and/or reassembly information, as discussed herein. In some embodiments, the segmentation is based on at least one of UL grant, TB size and the at least one signaling condition, as discussed herein. In some embodiments, the circuitry is further configured to detect a transmission mode change, as discussed herein. In some embodiments, the transmission mode change includes a dynamic change or a semi-static change, as discussed herein. In some embodiments, the dynamic change is indicated in the protocol data unit, as discussed herein. In some embodiments, the dynamic change is indicated in a subsequent transmission of the protocol data unit, as discussed herein. In some embodiments, the semi-static change is indicated via dedicated signaling, as discussed herein. In some embodiments, the dedicated signaling indicates in which subsequent transmission the transmission mode change happens, as discussed herein. In some embodiments, the circuitry is further configured to transmit a modified protocol data unit to the base station, such that the base station decodes the modified protocol data unit transmitted by the user equipment, as discussed herein.

Some embodiments pertain to methods for carrying out the present disclosure, which the skilled person will be able to carry out with the necessary amendments to the above and below parts of the description, such that an unnecessary description of such methods is omitted herein. Some embodiments pertain to a network entity for a mobile telecommunications network, wherein the network entity is configured to generate a predefined protocol data unit according to a predefined protocol of the mobile telecommunications network, the network entity comprising circuitry configured to: generate a modified protocol data unit based on a predefined context of the network entity.

The predefined context of the network entity may include an environment of the network entity, for example.

In some embodiments, the network entity constitutes an entity of an mMTC network, such that the network entity may be envisaged for a factory for example. Hence, the context of the network entity may be defined as mMTC or its environment. Another context may be autonomous driving, hospital machinery, home automation, “classical” cellular network, or the like. Also, combinations of multiple contexts may be envisaged. Hence, in some embodiments, the predefined context includes at least one of an environment of the network entity, mMTC, autonomous driving, hospital machinery, home automation, and end user cellular network.

UEs in such networks may have a need for tailored PDUs, for example, since not all PDU fields may be necessary depending on, the context.

For example, the context may be indicative of a quality of service (QoS) which may be different according to the context. For example, machines in a factory may have a need for a different QoS than a smartphone.

In conventional cellular network protocols, a required QoS for a specific service may be pre-defined (i.e. standardized). For example, when the service is requested, the bearer may be established based on, required QoS. After that, RAN parameters may be decided and configured for the RAN. Since in conventional network protocols all typical services (e.g. text, voice, or the like) are defined in advance, there was no need for having flexible PDU header formats. Hence, in such a conventional cellular network, a relation between a specific service and a network configuration may correspond to a one-to-one mapping.

However, if the services are not known, it has been recognized, that it may be desirable to provide a context aware network, as described herein. Hence, according to the present disclosure different service with different parameter values may be handled.

Such network entities may be directly or indirectly “aware” of their context. Either, their context may be predefined or their context may be learned.

As already discussed, for example a factory may constitute a context for the network entity, i.e. the present disclosure may be applied to an industry use case. For example, a customer may have a need for a new application which is not included in the pre-defined services. Furthermore, a network deployment may be varying, which may be taken into account be modifying the PDU based on the context.

For example, in a factory communication, a URLLC may provide a low latency service. However, the connected devices or equipment in the factory may vary. For example, if a video camera monitors safety of humans, it generates large volume of data, which may be considered as eMBB type traffic. A temperature sensor on water tank may generate (relatively) small volume of data, which may be considered as mMTC type traffic.

If the network entity is “aware” that it is used for motion control (e.g. for a robot in a factory), the network may be optimized for this context. Conventional factory networks may use a special network for motion control like Isochronous Real Time (IRT) communication due to specific requirements for the network. When it is recognized, in the context aware network, that a sensor is connected to the network for robot control, the network may be configured to select suitable protocols, and configurations, such as URLLC, e.g. time sensitive network (TSN), in order to meet the requirements of low latency and a predetermined time synchronization.

The network entity (e.g. a base station (e.g. TRP (transmission/reception, point))) may be installed on a ceiling of the factory, for example. A UE connected to the robot may be kept at a fixed position, such that a line of sight (LoS) and/or at least one stable radio condition to the UE may be maintained. Furthermore, a sensor UE for the robot control may be installed in a fixed position and a self-organized network (SON) function may configure the network based on the context and a dedicated protocol may be selected based on the context. However, the present disclosure is not limited in that regard that a line of sight has to be maintained. In some embodiments, the network entity (or its circuitry) may be configured to determine at least one stationary user equipment, such that a URLLC communication, for example, may be established. Additionally, the line of sight may be determined in that way, as well.

In some embodiments, the at least one stationary user equipment is determined based on control signaling between the network entity and the user equipment.

Hence, in some embodiments, in case of a massive machine type communication context, the modified protocol data unit is generated based on a self-organized network function.

Furthermore, in some embodiments, the circuitry is further configured to select a dedicated network protocol based on the context.

In some embodiments, the UE and/or the network may include a positioning function, such that the circuitry may be configured to collect/determine a UE and/or a TRP (network entity) position and/or a coverage. Furthermore, the circuitry may be configured to determine a mobile status (also including a stationary status) of the UE. Furthermore, a three-dimensional of the TRP or the UE may be determinable by the circuitry according to the present disclosure.

The mobile telecommunications network (e.g. a RAN) according to the present disclosure may utilize an application interface (API) to an external device (e.g. MEC (multi-access edge computing)), which may indicate a type of application and a deployment of nodes and/or of UEs, such that the context may be determined based on the API, for example.

In some embodiments, the circuitry is further configured to transmit configuration information to a user equipment, such that the user equipment is able to transmit a modified protocol data unit, as discussed herein.

In some embodiments the circuitry is further configured to receive the modified protocol data unit from the user equipment, as discussed herein.

In some embodiments, the circuitry is further configured to receive, from a user equipment, a modified protocol data unit and to decode the modified protocol data unit transmitted by the user equipment, as discussed herein.

In some embodiments, the decoding of the modified protocol data unit transmitted by the user equipment includes blind decoding, as discussed herein.

FIG. 9 is an exemplary diagram to describe a training of the artificial intelligence discussed herein.

In particular, FIG. 9 is a graph of a loss function against an input parameter value for different header formats, illustrating the principles underlying the training of the model.

In FIG. 9, the loss function E is plotted on the vertical axis, and the value of a parameter Ix is plotted on the horizontal axis. The parameter Ix represents an error source causing communication overhead. For example, if at least one signaling condition becomes worse, overhead may be increased due to an error and retransmission. In order to reduce the overhead, the artificial intelligence changes a PDU header (PDCP) format. Hence, the lines correspond to different possible PDCP header formats (associated with different HPDCP indices).

In general, it can be taken that for a given value of Ix, there is a corresponding header format which results in a minimal expected loss E. As part of the model training, such relationships between E, header format and parameter values may be determined to determine optimal header formats for given sets of input parameter values. In the example of FIG. 9, it can be taken that, for the particular input values shown, PDCP header having HPDCP=1 is preferred for Ix<A, HPDCP=2 is preferred for A<Ix<B, HPDCP=3 is preferred for B<Ix<C, and HPDCP=4 is preferred for Ix>C.

In other words: the loss function E is obtained based on minimizing the overhead. The overhead may be determined based on Tx bits, a number of bits including retransmission, headers, Rx bits, a number of received bits for user data. Furthermore, a difference between Tx bits and Rx bits may represent the overhead, such that the artificial intelligence may be trained to minimize this difference.

With such a machine learning algorithm employed by the artificial intelligence, a relation between any of two variables in a communication overhead may be taken into account. For example, any variable may be input to the artificial intelligence such that a correlation between the inputs and the between the inputs and the overhead may be determined during a training phase.

In contrast to this, in conventional communications, known relations are utilized for link adaptation, such as signal-to-noise ratio (SNR), and an output is generated (e.g. modulation and coding (MCS)), such that it is only known to investigate a two-variable relation (e.g. with simulation).

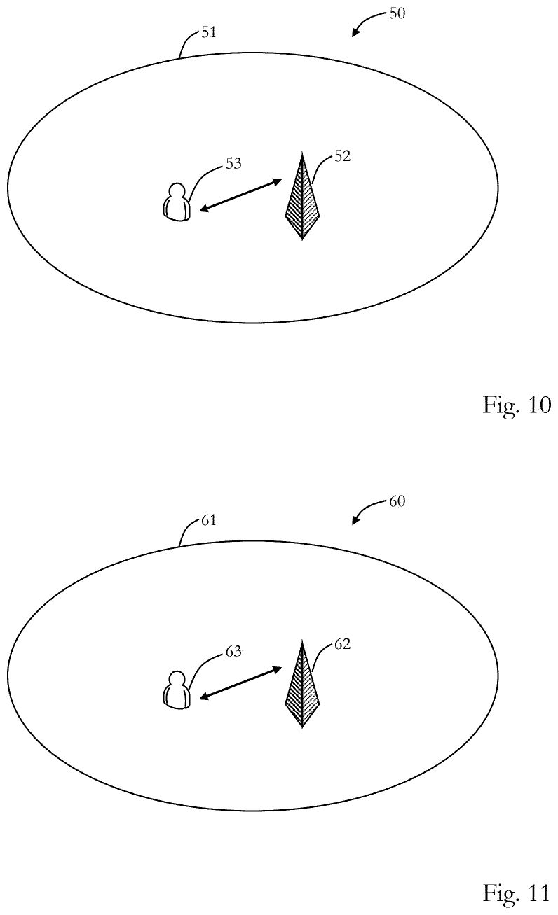

For illustration of the embodiments of the present disclosure, FIG. 10 schematically shows an embodiment of a deployment of a mobile telecommunications network 50.

A cell 51 is generated by a base station 52 for a mobile telecommunications system/network (here a gNB—“next generation eNodeB”). In this embodiment, the base station 52 is configured to transmit a predefined PDU, wherein the PDU can be represented by a layered structure, as discussed herein. Furthermore, the base station is configured to determine at least one signaling condition, as discussed herein. Based on the at, least one signaling condition, the base station is configured to adapt a number of signaling legs.

If the at least one signaling condition is “good” (i e fulfills a predetermined condition), the signaling legs are decreased, if the at least one signaling condition is bad (i.e. does not fulfill a predetermined condition), the signaling lags are increased. Furthermore, the PDU is distributed across the number of signaling legs, i.e. important information included, in the PDU is sent in a first subset of the signaling legs (or in all signaling legs), and unimportant information is sent in a second subset of the signaling legs.

Accordingly, a user equipment (UE) 53 is depicted which is configured to receive the PDU, which is distributed across the number of signaling legs. Therefore, the UE 53 is provided with the at least one signaling condition, such that the UE 53 can determine how the PDU is distributed across the number of signaling legs for receiving and re-assembling the PDU.

FIG. 11 schematically shows an embodiment of a deployment of a mobile telecommunications network 60.

A cell 61 is generated by a base station 62 for a mobile telecommunications system/network (here a gNB—“next generation eNodeB”). In this embodiment, the base station 62 is configured to transmit a predefined PDU, wherein the PDU can be represented by a layered structure, as discussed herein.

The base station is further configured to modify the predefined PDU, or, in other words, to generate a modified PDU, as discussed herein.

The modification, on the other hand, is indicated in a control part of the PDU. Hence, the control part includes an index, how the PDU is modified, which can then be mapped by a UE 63.

Accordingly, the user equipment (UE) 63 is depicted which is configured to receive the modified PDU and to decode and reassembly it accordingly.

The UE is further configured to determine a correspondence of layers of the modified PDU to layers of the predefined PDU, i.e. to map the index to the modification or to the predefined PDU.

Hence, some embodiments pertain to a user equipment, for a mobile telecommunications network including a network entity configured to generate a predefined protocol data unit according to a predefined protocol of the mobile, telecommunications network, the network entity comprising circuitry configured to: generate a modified protocol data unit based on a predefined context of the network entity, wherein the user equipment comprises circuitry configured to: receive the modified protocol data unit, as discussed herein. In some embodiments, the circuitry is further configured, to select a dedicated network protocol based on the context, as discussed herein. In some embodiments, the predefined context includes at least one of an environment of the network entity, massive machine type communication, autonomous driving, hospital machinery, home automation, and end user cellular network, as discussed herein. In some embodiments, in case of a massive machine type communication context, the modified protocol data unit is generated based on a self-organized network function, as discussed herein. In some embodiments, in case of a massive machine type communication context, wherein the circuitry is further configured to determine at least one stationary user equipment, as discussed herein. In some embodiments, the at least one stationary user equipment is determined based on control signaling between the network entity and the user equipment, as discussed herein. In some embodiments, in case of a massive machine type communication context, wherein the circuitry is further configured to determine at least one of a line of sight and at least one stable radio condition to a user equipment, as discussed herein. In some embodiments, the line of sight is determined based on control signaling between the network entity and the user equipment, as discussed herein. In some embodiments, the circuitry is further configured to determine at least one of a position and a coverage for at least one of a user equipment and the network entity, as discussed herein. In some embodiments, the circuitry is further configured to transmit, to the network entity, the modified protocol data unit based on configuration information provided by the base station, as discussed herein. In some embodiments, the circuitry is further configured to transmit a modified protocol data unit to the network entity, such that the network entity decodes the modified protocol data unit transmitted by the user equipment, as discussed herein.

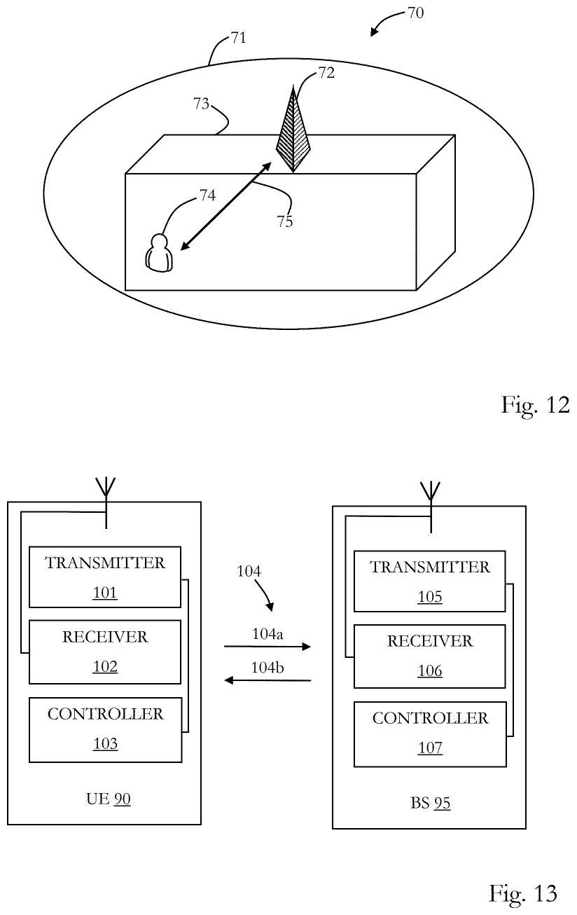

FIG. 12 schematically shows an embodiment of a deployment of a mobile telecommunications network 70.

A cell 71 is generated by a network entity 72 for a mobile telecommunications system/network (here a gNB—“next generation eNodeB”). In this embodiment, the network entity 72 is configured to transmit a predefined PDU, wherein the PDU can be represented by a layered structure, as discussed herein.

The network entity 72 is further configured to modify the predefined PDU, or, in other words, to generate a modified PDU based on a predefined context of the network entity.

In this embodiment, the predefined context is factory communication. Hence, the network entity 72 is provided on a factory 73, such that the cell 71 roughly spans the factory 73. In the factory 73, a UE 74 is provided, in this embodiment a mobile factory robot. A line of sight 75 is being maintained/determined based on control signaling between the UE 74 and the network entity 72. Hence, the network entity 72 as well as the UE 74 are each configured to maintain a line of sight to the respective other apparatus.

Hence, some embodiments pertain to a user equipment for a mobile telecommunications network including a-base station configured to generate a predefined protocol data unit according to a predefined protocol of the mobile telecommunications network, the base station comprising circuitry configured to: generate a modified protocol data unit, wherein a modification of the predefined protocol data unit is indicated in a control part of the protocol data unit, wherein the user equipment is configured to: receive the modified protocol data unit, as discussed herein. In some embodiments, the circuitry is further configured to determine a correspondence of layers of the modified protocol data unit to layers of the predefined protocol data unit, as discussed herein. In some embodiments, the modified protocol data unit includes a format indicator indicating the at least one modified protocol data unit, as discussed herein. In some embodiments, the format indicator is included in a control part of the at least one modified protocol data unit, as discussed herein. In some embodiments, the modified protocol data unit is based on a reordering of the predefined protocol data unit as discussed herein. In some embodiments, the modified protocol data unit is based on a compression of a predetermined part of the predefined protocol data unit, as discussed herein.

Accordingly, the user equipment (UE) 74 is depicted which is configured to receive the modified PDU and to decode and reassembly it accordingly.

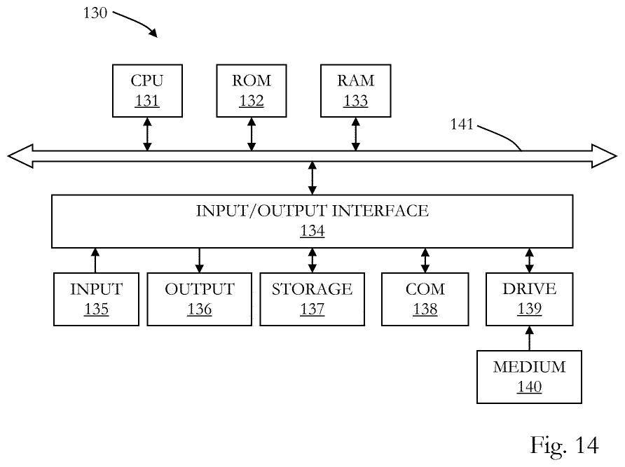

An embodiment of a UE 90 according to the present disclosure, a base station (BS) 95 according to the present disclosure (which can also be implemented as the network entity discussed herein) (e.g. NR eNB/gNB), a communication path 104 between the UE 90 and the BS 95, which are used for implementing embodiments of the present disclosure, is discussed under reference of FIG. 13.

The UE 90 has a transmitter 101, a receiver 102 and a controller 103, wherein, generally, the technical functionality of the transmitter 101, the receiver 102 and the controller 103 are known to the skilled person, and, thus, a more detailed description of these elements is omitted.

The BS 95 has a transmitter 105, a receiver 106 and a controller 107, wherein also here, generally, the functionality of the transmitter 105, the receiver 106 and the controller 107 are known to the skilled person, and, thus, a more detailed description of these elements is omitted.

The communication path 104 has an uplink path 104a, which is from the UE 90 to the BS 95, and a downlink path 104b, which is from the BS 95 to the UE 90.

During operation, the controller 103 of the UE 90 controls the reception of downlink signals over the downlink path 104b at the receiver 102 and the controller 103 controls the transmission of uplink signals over the uplink path 104a via the transmitter 101.

Similarly, during operation, the controller 107 of the BS 95 controls the transmission of downlink signals over the downlink path 104b over the transmitter 105 and the controller 107 controls the reception of uplink signals, over the uplink path 104a at the receiver 106.

In the following, an embodiment of a general purpose computer 130 is described under reference of FIG. 14.

The computer 130 can be implemented such that it can basically function as any type of user equipment, base station or new radio base station, transmission and reception point, or network entity, as discussed herein. The computer has components 131 to 141, which can form circuitry, such as any one of the circuitries of the base stations, network entity and user equipment, and the like, as described herein.

Embodiments which use software, firmware, programs or the like for performing the methods as described herein can be installed on computer 130, which is then configured to be suitable for the particular embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as a base station, network entity or as user equipment.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, etc.), loudspeakers, etc.

The storage 137 can have a hard disk, a solid state drive and the like.

The communication interface 138 can be adapted to communicate, for example, via a local area network (LAN), wireless local area network (WLAN), mobile telecommunications system (GSM, UMTS, LTE, NR etc.), Bluetooth, infrared, etc.

It should be noted that the description above only pertains to an example configuration of computer 130. Alternative configurations may be implemented with additional or other sensors, storage devices, interfaces or the like. For example, the communication interface 138 may support other radio access technologies than UMTS, LTE and NR, or the like.

When the computer 130 functions as a base station, the communication interface 138 can further have a respective air interface (providing e.g. E-UTRA protocols OFDMA (downlink) and SC-FDMA (uplink)) and network interfaces (implementing for example protocols such as S1-AP GTP-U, S1-MME, X2-AP, or the like). The computer 130 is also implemented to transmit data in accordance with TCP. Moreover, the computer 130 may have one or more antennas and/or an antenna array. The present disclosure is not limited to any particularities of such protocols.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

All units and entities described in this specification and claimed in the appended claims can, if not stated otherwise, be implemented as integrated circuit logic, for example on a chip, and functionality provided by such units and entities can, if not stated otherwise, be implemented by software, such that it is appreciated that corresponding methods are envisaged by the skilled person without an extensive description thereof herein.

In so far as the embodiments of the disclosure described above are implemented, at least in part, using software-controlled data processing apparatus, it will be appreciated that a computer program providing such software control and a transmission, storage or other medium by which such a computer program is provided are envisaged as, aspects of the present disclosure.

Note that the present technology can also be configured as described below.
(1) A base station for a mobile telecommunications network, wherein the base station is configured to transmit a predefined protocol data unit according to a predefined protocol of the mobile telecommunications network across a number of signaling legs, the base station comprising circuitry configured to:
   adapt the number of signaling legs based on at least one signaling condition, wherein, the protocol data unit is distributed across the number of signaling legs.
(2) The base station of (1), wherein the at least one signaling conditions includes at least one of a radio condition, a service requirement, and a data size
(3) The base station of (2), wherein the at least one radio condition includes: reference signal receiver power, channel quality indicator, block error rate.
(4) The base station of anyone of (1) to (3), wherein the circuitry is further configured to transmit at least one modified protocol, data unit across the number of signaling legs.
(5) The base station of (4), wherein the circuitry is further configured to transmit configuration information to a user equipment, such that the user equipment is able to transmit the modified protocol data unit.
(6) The base station of (5), wherein the circuitry is further configured to receive the modified protocol data unit from the user equipment.
(7). The base station of anyone of (4) to (6), wherein the at least one modified protocol data unit is generated by an artificial intelligence.
(8) The base station of (7), wherein a training input for the artificial intelligence includes at least one of the at least one signaling condition, a mobility status, at least one service requirement, a packet size, and position information.
(9) The base station of (8), wherein the mobility status includes high speed, nomadic, or static.
(10) The base station of (8) or (9), wherein the at least one service requirement includes enhanced mobile broadband, low latency, high reliability.
(11) The base station of anyone of (8) to (10), wherein the position includes cell center or cell edge.
(12) The base station of anyone of (4) to (11), wherein a modified protocol data unit is generated for each signaling leg of the number of signaling legs.
(13) The base station of anyone of (4) to (12), wherein the modified protocol data unit includes a format indicator indicating the at least one modified protocol data unit.
(14) The base station of (13), wherein the format indicator is included in a control part, of the at least one modified protocol data unit.
(15) The base station of anyone of (4) to (14), wherein the at least one modified protocol data unit is based on a reordering of the predefined protocol data unit.
(16) The base station of anyone of (4) to (15), wherein the at least one modified protocol data unit is based on a compression of a predetermined part of the predefined protocol data unit.
(17) The base station of anyone of (1) to (16), wherein the adaption of the number, of signaling legs is further based on a predetermined context of the base station.
(18) The base station of anyone of (1) to (17), wherein the adaption of the number of signaling legs is further based on a packet size.
(19) The base station of anyone of (1) to (18), wherein the circuitry is further configured to exchange assistance information with a user equipment.
(20) The base station of (19), wherein the assistance information is indicative of the distribution of the protocol data unit across the number of signaling legs.
(21) The base station of (19) or (20), wherein the assistance information is indicative for at least one of the at least one signaling condition.
(22) The base station of anyone of (1) to (21), wherein the predefined protocol data unit is distributed across the number of signaling legs based on at least one of segmentation information and reassembly information.
(23) The base station of (22), wherein the segmentation is based, on at least one of uplink grant, transport block size and the at least one signaling condition.
(24) The base station of (23), wherein the at least one of uplink grant, transport block size and the at least one signaling condition is used as a training input for an artificial intelligence.
(25) The base station of anyone of (1) to (24), wherein, if it is determined that the at least one signaling condition has not changed for a predetermined amount of time, the circuitry is further configured to reduce the number of signaling legs.
(26) The base station of anyone of (1) to (25), wherein the circuitry is further configured to carry out a transmission mode change dynamically or semi-statically based on the number of signaling legs.
(27) The base station of (26), wherein a dynamic change is indicated in the protocol data unit.
(28) The base station of (26) or (27), wherein a dynamic change is indicated in a subsequent transmission of the protocol data unit.
(29) The base station of (26), wherein a semi-static change is indicated via dedicated signaling.
(30) The base station of (29), wherein the dedicated signaling indicates in which subsequent transmission the transmission mode change happens.
(31) The base station of anyone of (1) to (30), wherein the circuitry is further configured to receive a modified protocol data unit from the user equipment and to decode the modified protocol data unit.
(32) The base station of (31), wherein the decoding of the modified protocol data unit includes blind decoding.
(33) A user equipment for a mobile telecommunications network including a base station configured to transmit a predefined protocol data unit according to a predefined protocol of the mobile telecommunications network across a number of signaling legs, the base station comprising circuitry configured to: adapt the number of signaling legs based on at least one signaling condition, wherein the protocol data unit is distributed across the number of signaling legs, wherein the user equipment comprises circuitry configured to:
   receive the predefined protocol data unit across the number of signaling legs.
(34) The user equipment of (33), wherein the at least one signaling conditions includes at least one of a radio condition a service requirement, and a data size.
(35) The user equipment of (34), wherein the at least one radio condition includes: reference signal receiver power, channel quality indicator, block error rate.
(36) The user equipment of anyone of (33) to (35), wherein the circuitry is further configured to transmit, to the base station, the modified protocol data unit across the number of signaling legs.
(37) The user equipment of anyone of (33) or (36), wherein the circuitry is further configured to receive at least one modified protocol data unit across the number of signaling legs.
(38) The user equipment of (37), wherein the circuitry is further configured to transmit, to the base station, the at least one modified protocol data unit across the number of signaling legs based on configuration information provided by the base station.
(39) The user equipment of (37) or (38), wherein the at least one modified protocol data unit is based on a reordering of the predefined protocol data unit.
(40) The user equipment of anyone of (37) to (39), wherein the modified protocol data unit includes a format indicator indicating the at least one modified protocol data unit.
(41) The user equipment of (40), wherein the format indicator is included in a control part of the at least one modified protocol data unit.
(42) The user equipment of anyone of (37) to (41), wherein the at least one modified protocol data unit is based on a compression of a predetermined part of the predefined protocol data unit.
(43) The user equipment of anyone of (33) to (42), wherein the circuitry is further configured to exchange assistance information with the base station.
(44) The user equipment of (43), wherein the assistance information is indicative of the distribution of the protocol data unit across the number of signaling legs.
(45) The user equipment of (43) or (44), wherein the assistance information is indicative for at least one of the at least one signaling condition.
(46) The user equipment of anyone of (33) to (45), wherein the predefined protocol data unit is distributed across the number of signaling legs based on at least one of segmentation information and reassembly information.
(47) The user equipment of (46), wherein the segmentation is based on at least one of uplink grant, transport block size and the at least one signaling condition.
(48) The user equipment of (46) or (47), wherein the circuitry is further configured to detect a transmission mode change.
(49) The user equipment of (48), wherein the transmission mode change includes a dynamic change or a semi-static change.
(50) The user equipment of (49), wherein a dynamic change is indicated in the protocol data unit.
(51) The user equipment of (49) or (50), wherein a dynamic change is indicated in a subsequent transmission of the protocol data unit.
(52) The user equipment of anyone of (49) to (51), wherein a semi-static change is indicated via dedicated signaling.
(53) The user equipment of (52), wherein the dedicated signaling indicates in which subsequent submission the transmission mode change happens.
(54) The user equipment of anyone of (33) to (53), wherein the circuitry is further configured to transmit a modified protocol data unit to the base station, such, that the base station decodes the modified protocol data unit, transmitted by the user equipment.
(55) A network, entity for a mobile telecommunications network, wherein, the network entity is configured, to generate a predefined protocol data unit according to a predefined protocol of the mobile telecommunications network, the network entity comprising circuitry configured to:
   generate a modified protocol data unit based, on a predefined context of the network entity.
(56) The network entity of (55), wherein the circuitry is further configured to select a dedicated network protocol based on the context.
(57) The network entity of (55) or (56), wherein the predefined context includes at least one of an environment of the network entity, massive machine type communication, autonomous driving, hospital machinery, home automation, and end user cellular network.
(58) The network entity of (57), in case of a massive machine type communication context, the modified protocol data unit is generated based on a self-organized network function.
(59) The network entity of (57) or (58), in case of a massive machine type communication context, wherein the circuitry is further configured to determine at least one of a line of sight and at least one stable radio condition to a user equipment.
(60) The network entity of (59), wherein the line of sight is determined based on control signaling between the network entity and the user equipment.
(61) The network entity of anyone of (57) to (60), in case of a massive machine type communication context, the circuitry is further configured to determine at least one stationary user equipment.
(62) The network entity of (61), wherein the at least one stationary user equipment is determined based on control signaling between the network entity and the user equipment.
(63) The network entity of anyone of (55) to (62), wherein the circuitry is further configured to determine at least one of a position and a coverage for at least one of a user equipment and the network entity.
(64) The network entity of anyone of (55) to (63), wherein the circuitry is further configured to transmit configuration information to a user equipment, such that the user equipment is able to transmit a modified protocol data unit.
(65) The network entity of (64), wherein the circuitry is further configured to receive the modified protocol data unit from the user equipment.
(66) The network entity of anyone of (55) to (65), wherein the circuitry is further configured to receive, from a user equipment, a modified protocol data unit and to decode the modified protocol data unit transmitted by the user equipment.
(67) The network entity of (66), wherein the decoding of the modified protocol data unit transmitted by the user equipment includes blind decoding.
(68) A user equipment for a mobile telecommunications network including a the network entity configured to generate a predefined protocol data unit according to a predefined protocol of the mobile telecommunications network, the network entity comprising circuitry configured to: generate a modified protocol data unit based on a predefined context of the network entity, wherein the user equipment comprises circuitry configured to:
   receive the modified protocol data unit.
(69) The user equipment of (68), wherein the circuitry is further configured to select a dedicated network protocol, based on the context.
(70) The user equipment of (68) or (69), wherein the predefined context includes at least one of an environment of the network entity, massive machine type communication, autonomous driving, hospital machinery, home automation, and end user cellular network.
(71) The user equipment of (70), in case of a massive machine type communication context, the modified-protocol data unit is generated based on, a self-organized network function.
(72) The user equipment of (70), in case of a massive machine type communication context, the circuitry is further configured to determine at least one stationary user equipment.
(73) The user equipment of (72), wherein the at, least one stationary user equipment is determined based on control signaling between the network entity and the user equipment.
(74) The user equipment of anyone of (70) to (73), in case of a massive machine type communication context, wherein the circuitry is further configured to determine at least one of a line of sight and at least one stable radio condition to a user equipment.
(75) The user equipment of (74), wherein the line of sight is determined based on control signaling between the network entity and the user equipment.
(76) The user equipment of anyone of (68) to (75), wherein the circuitry is further configured to determine at least one of a position and a coverage for at least one of a user equipment and the network entity.
(77) The user equipment of anyone of (68) to (76), wherein the circuitry is further configured to transmit, to the network entity, the modified protocol data unit based on configuration information provided by the base station.
(78) The user equipment of (77), wherein the circuitry is further configured to transmit a modified protocol data unit to the network entity, such that the network entity decodes the modified protocol data unit transmitted by the user equipment.
(79) A base station for a mobile telecommunications network, wherein the base station is configured to generate a predefined protocol data unit according to a predefined protocol of the mobile telecommunications network, the base station comprising circuitry configured to:
   generate a modified protocol data unit, wherein a modification of the predefined protocol data unit is indicated in a control part of the protocol data unit.
(80) The base station of (79), wherein the modified protocol data unit includes a format indicator indicating the at least one modified protocol data unit.
(81) The base station of (80), wherein the format indicator is included in a control part of the at least one modified protocol data unit.
(82) The base station of anyone of (79) to (81), wherein the modified protocol data unit is based on a reordering of the predefined protocol data unit.
(83) The base station of anyone of (79) to (82), wherein the modified protocol data unit is based on a compression of a predetermined part of the predefined protocol data unit.
(84) The base station of anyone of (79) to (83), wherein the circuitry is further configured to transmit configuration information to a user equipment, such that the user equipment is able to transmit the modified protocol data unit.
(85) The base station of (84), wherein the circuitry is further configured to receive the modified protocol data unit from the user equipment.
(86) The base station of anyone of (79) to (85), wherein the circuitry is further configured to receive a modified protocol data unit from the user equipment and to decode the modified protocol data unit.
(87) The base station of (86), wherein the decoding of the modified protocol data unit includes blind decoding.
(88) A user equipment for a mobile telecommunications network including a base station configured to generate a predefined protocol data unit according to a predefined protocol of the mobile telecommunications network, the base station comprising circuitry configured to: generate a modified protocol data unit, wherein a modification of the predefined protocol data unit is indicated in a control part of the protocol data unit, wherein the user equipment is configured to:
   receive the modified protocol data unit.
(89) The user equipment of (88), wherein the circuitry is further configured to determine a correspondence of layers of the modified protocol data unit to layers of the predefined protocol data unit.
(90) The user equipment of (88) or (89), wherein the modified protocol data unit includes a format indicator indicating the at least one modified protocol data unit.
(91) The user equipment of (90), wherein the format indicator is included in a control part of the at least one modified protocol data unit.
(92) The user equipment of anyone of (88) to (91), wherein the modified protocol data unit based on a reordering of the predefined protocol data unit.
(93) The user equipment of anyone of (88) to (92), wherein the modified protocol data unit is based on a compression of a predetermined part of the predefined protocol data unit (94) The user equipment of anyone of (88) to (93), wherein the circuitry is further configured to transmit, to the base station, the modified protocol data unit based on configuration information provided by the base station.
(95) The user equipment of anyone of (88) to (94), wherein the circuitry is further configured to transmit a modified protocol data unit to the base station, such that the base station, decodes the modified protocol data unit transmitted by the user equipment.

1. A base station for a mobile telecommunications network, wherein the base station is configured to transmit a predefined protocol data unit according to a predefined protocol of the mobile telecommunications network across a number of signaling legs, the base station comprising circuitry configured to:
adapt the number of signaling legs based on at least one signaling condition, wherein the protocol data unit is distributed across the number of signaling legs.

2. The base station of claim 1, wherein the at least one signaling conditions includes at least one of a radio condition, a service requirement, and a data size.

3. The base station of claim 2, wherein the at least one radio condition includes: reference signal receiver power, channel quality indicator, block error rate.

4. The base station of claim 1, wherein the circuitry is further configured to transmit at least one modified protocol data unit across the number of signaling legs.

5. The base station of claim 4, wherein the circuitry is further configured to transmit configuration information to a user equipment, such that the user equipment is able to transmit the modified protocol data unit.

6. The base station of claim 5, wherein the circuitry is further configured to receive the modified protocol data unit from the user equipment.

7. The base station of claim 4, wherein the at least one modified protocol data unit is generated by an artificial intelligence.

8. The base station of claim 7, wherein a training input for the artificial intelligence includes at least one of the at least one signaling condition, a mobility status, at least one service requirement, a packet size, and position information.

9.-32. (canceled)

33. A user equipment for a mobile telecommunications network including a base station configured to transmit a predefined protocol data unit according to a predefined protocol of the mobile telecommunications network across a number of signaling legs, the base station comprising circuitry configured to: adapt the number of signaling legs based on at least one signaling condition, wherein the protocol data unit is distributed across the number of signaling legs, wherein the user equipment comprises circuitry configured to:
receive the predefined protocol data unit across the number of signaling legs.

34. The user equipment of claim 33, wherein the at least one signaling conditions includes at least one of a radio condition, a service requirement, and a data size.

35. The user equipment of claim 34, wherein the at least one radio condition includes: reference signal receiver power, channel quality indicator, block error rate.

36. The user equipment of claim 33, wherein the circuitry is further configured to transmit, to the base station, the modified protocol data unit across the number of signaling legs.

37. The user equipment of claim 33, wherein the circuitry is further configured to receive at least one modified protocol data unit across the number of signaling legs.

38.-42. (canceled)

43. The user equipment of claim 33, wherein the circuitry is further configured to exchange assistance information with the base station.

44.-45. (canceled)

46. The user equipment of claim 33, wherein the predefined protocol data unit is distributed across the number of signaling legs based on at least one of segmentation information and reassembly information.

47.-54. (canceled)

55. A network entity for a mobile telecommunications network, wherein the network entity is configured to generate a predefined protocol data unit according to a predefined protocol of the mobile telecommunications network, the network entity comprising circuitry configured to:
generate a modified protocol data unit based on a predefined context of the network entity.

56. The network entity of claim 55, wherein the circuitry is further configured to select a dedicated network protocol based on the context.

57. The network entity of claim 55, wherein the predefined context includes at least one of environments of the network entity, massive machine type communication, autonomous driving, hospital machinery, home automation, and end user cellular network.

58. The network entity of claim 55, in case of a massive machine type communication context, the modified protocol data unit is generated based on a self-organized network function.

59. The network entity of claim 55, in case of a massive machine type communication context, wherein the circuitry is further configured to determine at least one of a line of sight and at least one stable radio condition to a user equipment.

60.-95. (canceled)
